(19) United States
(12) Patent Application Publication
(10) Pub. No.: US 2011/0181040 A1
(43) Pub. Date: Jul. 28, 2011

(54) SAMPLE PAINT CONTAINER ADAPTER FOR PAINT SPRAYER

(75) Inventors: David J. Thompson, Oak Grove, MN (US); Dale D. Johnson, Shoreview, MN (US)

(73) Assignee: GRACO MINNESOTA INC., Minneapolis, MN (US)

(21) Appl. No.: 13/014,304

(22) Filed: Jan. 26, 2011

Related U.S. Application Data
(60) Provisional application No. 61/298,748, filed on Jan. 27, 2010.

(51) Int. Cl. F16L 55/00

(52) U.S. Cl. 285/148.23

(57) ABSTRACT

This invention allows a hand held paint sprayer 10 to quickly adapt to industry standard “sample” paint containers 12. This allows for end users to quickly attach this sample product to a hand held airless sprayer and spray the paint color sample on the wall or substrate. An adaptor ring adapts 14 from hand held product hopper section 16 with threads 18 to the sample paint product containers 12 with threads 20.

### TECHNICAL FIELD

This application claims the benefit of U.S. Application Ser. No. 61/298,748, filed Jan. 27, 2010, the contents of which are hereby incorporated by reference.

### BACKGROUND ART

Various type of “cup guns” or handheld sprayers have been known for many years and typically utilize a bespoke metal or plastic cup which may be removed to add paint and then screwed to the gun. In more recent years, paint manufacturers have provided paint in small sample containers to enable the painter or homeowner to paint a small area to see how the color looks in the actual location. Such sample containers are typically much smaller than the cups used and provided with the handheld sprayers.

### DISCLOSURE OF THE INVENTION

It is an object of this invention to allow a hand held paint sprayer 10 to quickly adapt to industry standard “sample” paint containers 12. This allows for end users to quickly attach this “sample” product to a hand held airless sprayer and spray the paint color sample on the wall or substrate.

An adaptor ring 14 connects from hand held product hopper section 16 with threads 18 to the sample paint and coating product containers 12 with threads 20. This can be done in a number of methods, threads being the preferred embodiment. Other options for doing so include thread and clamp, clamp and clamp and snap fit to snap fit or direct connection to the body if desired.

The advantages of the instant invention include quick set up and sample spray for the customer as there is no requirement of dirtying another container. It also allows pulling material direct out of sample container and provides quick clean up of the sprayer and disposal of the sample container.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows a typical sample container.

FIG. 2 shows a thread adapter of the instant invention.

FIG. 3 shows a hand held sprayer utilizing the thread adapter of the instant invention with the sample container in place for spraying.

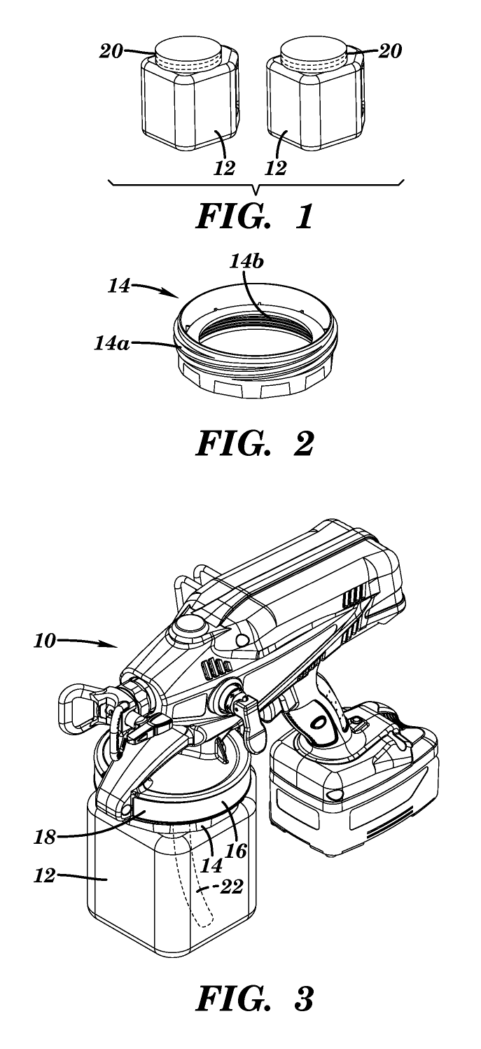

### BEST MODE FOR CARRYING OUT THE INVENTION

It is an object of this invention to allow a hand held paint sprayer 10 to quickly adapt to industry standard “sample” paint containers 12. This allows for end users to quickly attach this “sample” product to a hand held airless sprayer and spray the paint color sample on the wall or substrate.

An annular shaped adaptor ring adapts 14 from hand held product hopper section 16 with threads 18 to the sample paint product containers 12 with threads 20. This can be done in a number of methods, threads being the preferred embodiment. Other options for doing so include thread and clamp, clamp and clamp and snap fit to snap fit. First connector element threads 14a on adapter 14 are designed to engage threads 18 on sprayer 10 while second connector element threads 14b on adapter 14 are designed to engage threads 20 on sample container 12.

The axial length of the adapter ring is designed so that the suction tube 22 is placed at the proper depth in the sample container 12 to enable substantial emptying of the container 12.

It is contemplated that various changes and modifications may be made to the paint container adapter without departing from the spirit and scope of the invention as defined by the following claims.

1. An adapter element for adapting a coating sample container to a handheld sprayer, said adapter element having a generally annular shape and an axial length and comprising a first connector element to engage said sprayer and a second connector element to engage said coating sample container.

2. The adapter element of claim 1 wherein said sprayer comprises threads and second first connector element comprises threads for engaging said sprayer threads.

3. The adapter element of claim 1 wherein said sample container comprises threads and second connector element comprises threads for engaging said sample container threads.

4. The adapter element of claim 1 wherein said sprayer comprises a suction tube and said sample container comprises a bottom wherein said axial length is such that said suction tube is placed adjacent said bottom when said sample container is attached to said sprayer with said adapter ring.
